(19) United States
(12) Patent Application Publication
(10) Pub. No.: US 2015/0061869 A1
(43) Pub. Date: Mar. 5, 2015

(54) Building Intruder Defensive Shield

(71) Applicants: Jody Crowe, Eagan, MN (US); Tedd Johnson, Elko, MN (US)

(72) Inventors: Jody Crowe, Eagan, MN (US); Tedd Johnson, Elko, MN (US)

(21) Appl. No.: 14/475,516

(22) Filed: Sep. 2, 2014

Related U.S. Application Data
(60) Provisional application No. 61/873,214, filed on Sep. 3, 2013.

(51) Int. Cl. G08B 15/00; G08B 13/22

(52) U.S. Cl. CPC G08B 15/00; G08B 13/22
USPC 340/541

(57) ABSTRACT

This invention relates to a building intruder defensive shield system to deter, delay and distract intruders from causing damage or harm upon entering and roaming buildings. The defensive shield system includes a cold water supply plumbed to an expansion tank capable of pressurizing the water with a zone valve and nozzle. A motion sensor, control relay, and a central processing unit communicate signals to and from each other and the zone valve to disperse a timed, forced spray of water, preferably containing dye or a chemical irritant, on the intruder. Manual or gunshot detection means are included to identify and locate the intruder.

This application claims the filing date of and relates to the provisional application by the same inventors, Ser. No. 61/873,214 filed on Sep. 3, 2013.

### BACKGROUND OF THE INVENTION

### Field of the Invention

This invention relates to a defensive shield system to deter, delay and distract intruders from causing damage or harm upon entering and roaming buildings.

Many buildings have systems to suppress fires until the fire department arrives, but none have a system inside the building to suppress active shooters who breech protected or unprotected entrances or who become active when inside of buildings. The unprotected interior of buildings gives an active shooter or any violent perpetrator unfettered access to victims, a veritable ‘reign of terror’ until the perpetrator is confronted by someone who risks their life, by law enforcement, or the perpetrator chooses to desist. The present invention provides a built-in non-lethal defensive system to deter, distract, and delay human threats inside of a building, public or private, commercial or home, until law enforcement arrives.

### SUMMARY OF THE INVENTION

The defensive shield system uses torrents of pressurized cold water delivered through nozzles as a shield to deter, delay, and distract violent perpetrators inside of a building. The system can be plumbed in as a stand-alone system or can utilize the building fire suppression sprinkler water delivery system for cold water delivery to the nozzles. Cold water, infused with an optional eye or throat irritant or a forensic dye agent or both, becomes a defensive shield when the system is activated. System activation occurs when gunshot detection devices detect a gunshot and/or by visual recognition of a threat by building occupants.

### DETAILED DESCRIPTION OF INVENTION

The defensive shield system can be activated by visual observation of an intruder and/or by a sound recognition system, such as a gunshot detection activation system.

Visual Activation of System for Commercial Application.

In one embodiment of the invention, one or more building intruder defensive shield modules are installed in entrances, hallways, offices, conference rooms, classrooms, or other areas throughout the building, as determined by the building owner. When there is a visual recognition of a threat or of an active shooter, building personnel utilize proximity sensor remote activation devices that are strategically placed throughout the building to arm and activate the building intruder defensive shield system. The proximity sensor remote activation devices are strategically placed throughout the building for quick response by building occupants. A building occupant would visually identify the intruder and the intruder's location, and activate the building intruder defensive shield in that zone. Upon activation, the proximity sensor remote activation device sends a signal to a central processing computer, which then triggers open the valve in the identified zone; spraying a timed burst of cold water throughout that zone. The preferred embodiment would have the water infused with a chemical deterrent, a forensic dye, or the like, for deterring, incapacitating or marking the intruder. Also upon activation, a building-wide lockdown alarm is sounded and the building occupants follow their lockdown procedures. A software-driven building-specific countdown to an automation stage begins. The building-specific countdown time is determined by the length of time reported by the building occupants for the building to be in full lockdown. When reaching the automation stage, strategically placed sensor devises sense movement and relay the signal to the control panel. The central processing computer opens the valves for a pre-determined time in the zones where movement is sensed. This function of the control panel creates a moving “raincloud” effect to keep the intruder distracted and moving to escape the water.

Gunshot Detection Activation of System for Commercial Application.

In another embodiment of the invention, building intruder defensive shield modules are installed in entrances, hallways, offices, conference rooms, classrooms, or other areas throughout the building, as determined by the building owner. Gunshot detection devices are strategically placed throughout the building for optimum gunshot location capabilities. When a gunshot occurs at an entrance or within the building, the gunshot detection devices relay the sound of the gunshot to a gunshot detection peripheral connected to the control panel. Detection and identification of a gunshot signature by the gunshot detection peripheral immediately provides the location of the intruder within a threatened zone.

The central processing computer activates the zone identified as the location where the gunshot occurred, sending a signal to open the valve spraying a timed burst of cold water throughout that zone. Again, the preferred embodiment would have the water infused with a chemical deterrent, a forensic dye, or the like, for deterring, incapacitating or marking the intruder. Motion detection devices in close proximity to the activated zone are immediately armed for immediate recognition of movement. A building-wide lockdown alarm is sounded and the building occupants follow their lockdown procedures. A software-driven building-specific countdown to automation begins. (This building-specific countdown time is determined by the length of time reported by the building occupants for the building to be in full lockdown.)

When reaching the automation stage, strategically placed devises sense movement and relay the signal to the control panel. The central processing computer opens the valves for a pre-determined time in the zones where movement is sensed. This function of the control panel creates a moving “raincloud” effect to keep active perpetrator distracted and moving to escape the water.

Home Invasion Protection.

In another embodiment of the invention, building intruder defensive shield modules are installed in strategic locations for maximum protection with emphasis on entrances to the home. Remote activation devices are strategically placed throughout a home to arm and activate the building intruder defensive shield system when there is a visual recognition of a threat to the health/life of a member of the family. Remote activation devices are strategically placed throughout the home for quick response by any member of the family. Upon activation, the remote activation device sends a signal to the central processing computer, which then triggers open the valve in the identified zone; spraying a timed burst of cold (optional deterrent and forensic dye laden) water throughout that zone. Upon activation, an alarm is sent to dispatch law enforcement.

The system control comprises a central processing computer, a software application means for recognizing sensor alerts, sending activation signals to a valve to turn on and off the water sprayed from the valve, a gunshot detection peripheral sensor device, a hard wired or wireless local area network (LAN) for system communication, and software applications to be used by mobile devices/wireless computers for delivery of system information to law enforcement and building occupants.

Computer hardware and software application means provide the logic and processing within the central processing computer. Commercially available gunshot detection peripheral sensor devices provide data that is processed to determine the location in or around the building of the threat. The central processing computer uses built-in logic to determine when automation of valve activation occurs, length of time zone valves are open, and timing and sequence of automated responses. All inputs and outputs are transmitted via hardwired or wireless LAN to the modules. The central processing computer produces data on the location of activated zones and detection devices, provides remote control of system, and sends data via apps to remote communication devices, such as smart phones, laptops, tablets, IPads, etc., to be used by law enforcement and building personnel.

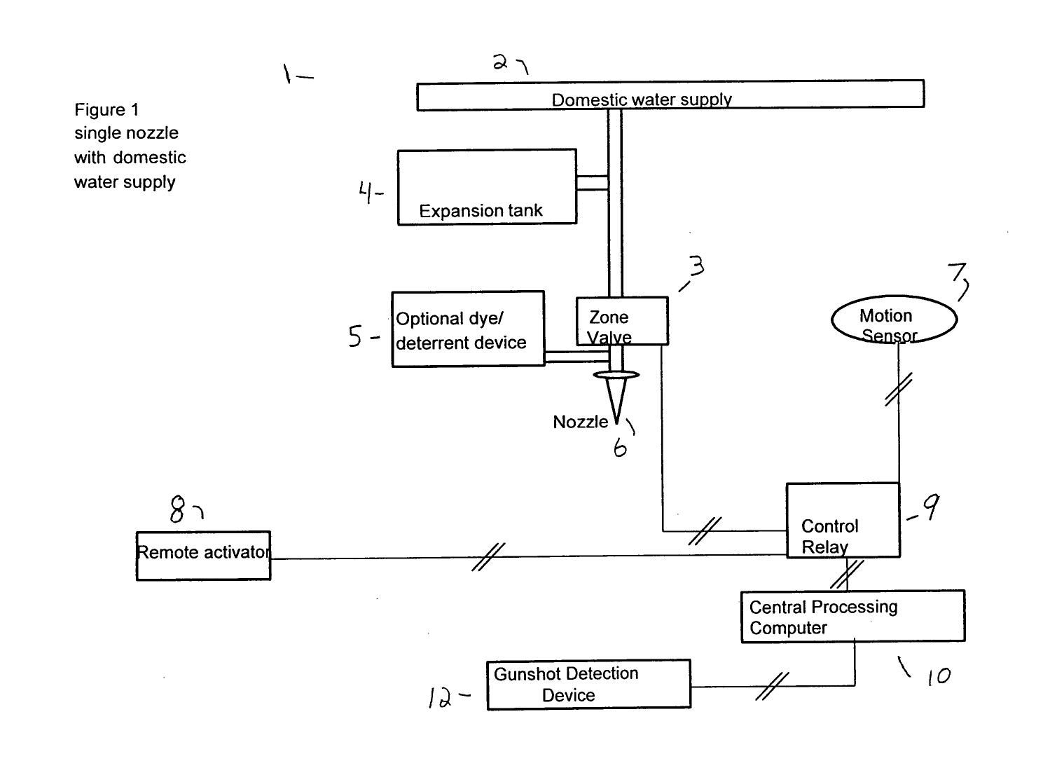

FIG. 1 shows an embodiment of a module using a domestic water supply with one zone valve and one nozzle.

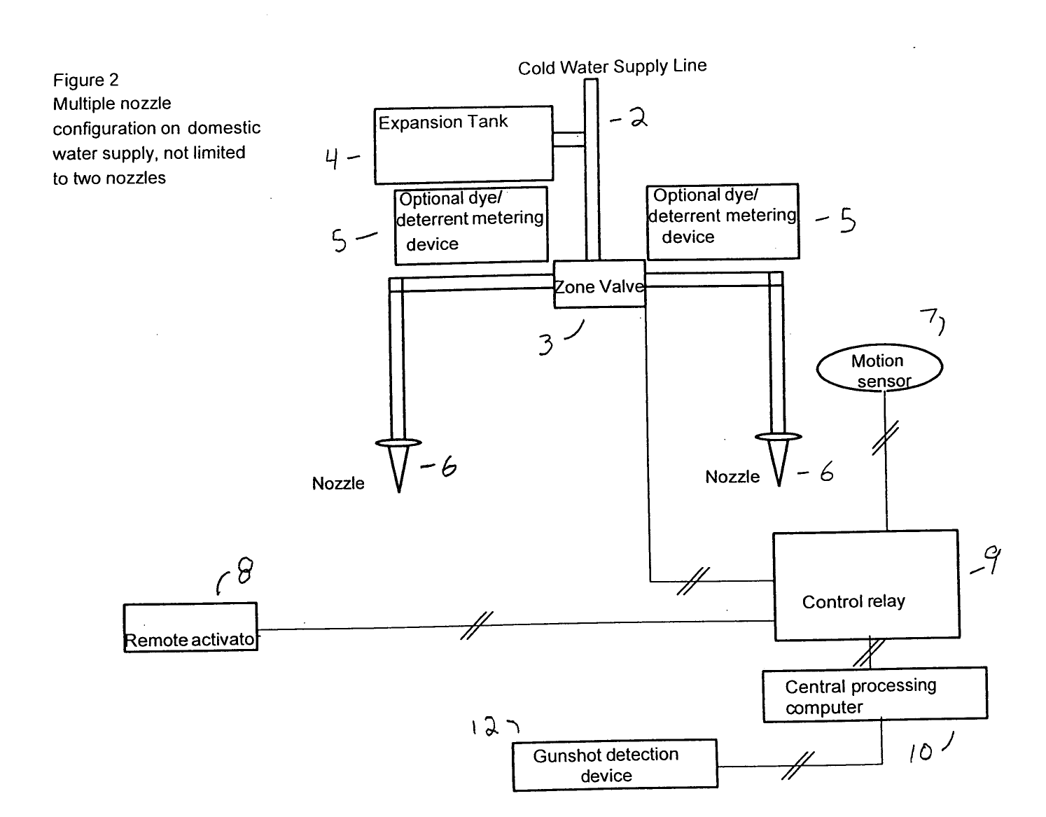

FIG. 2 shows an embodiment of a module using a domestic water supply and one zone valve and multiple nozzles.

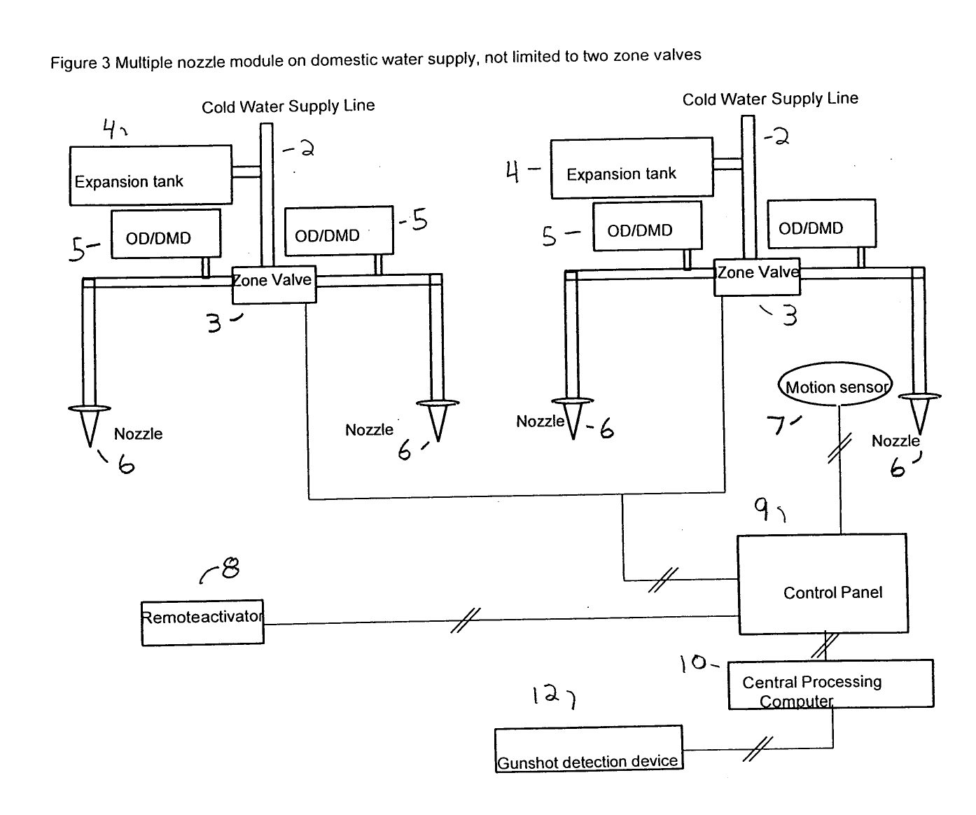

FIG. 3 shows an embodiment of a module using a domestic water supply with multiple valves and multiple nozzles.

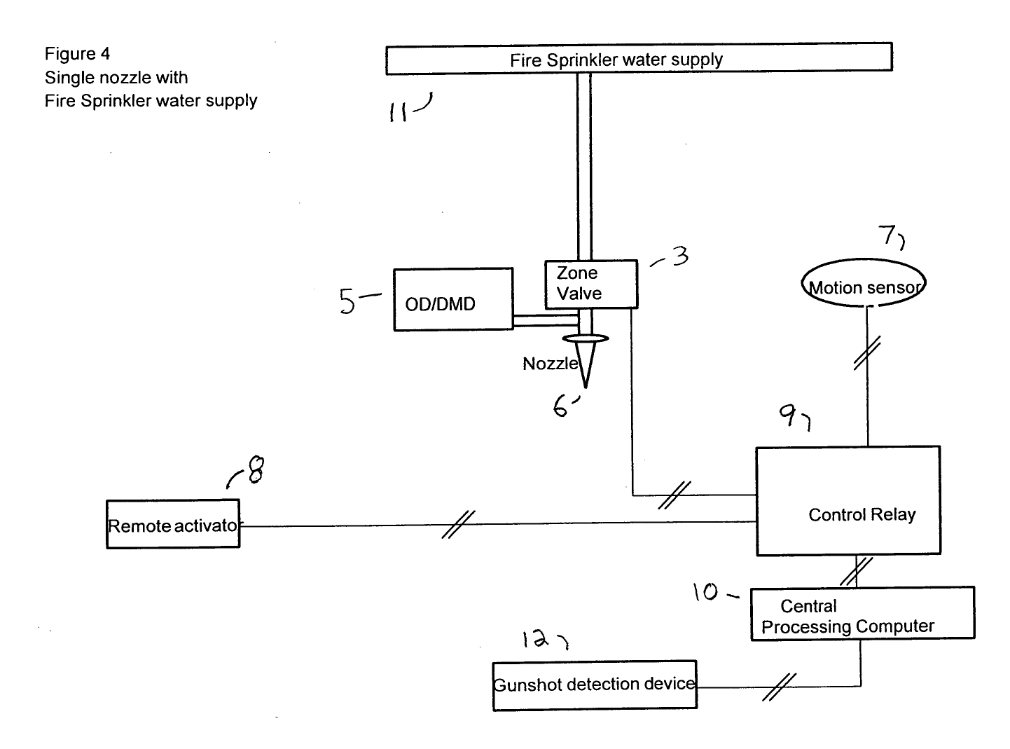

FIG. 4 shows an embodiment of a module using a fire sprinkler water supply with a single zone valve and single nozzle.

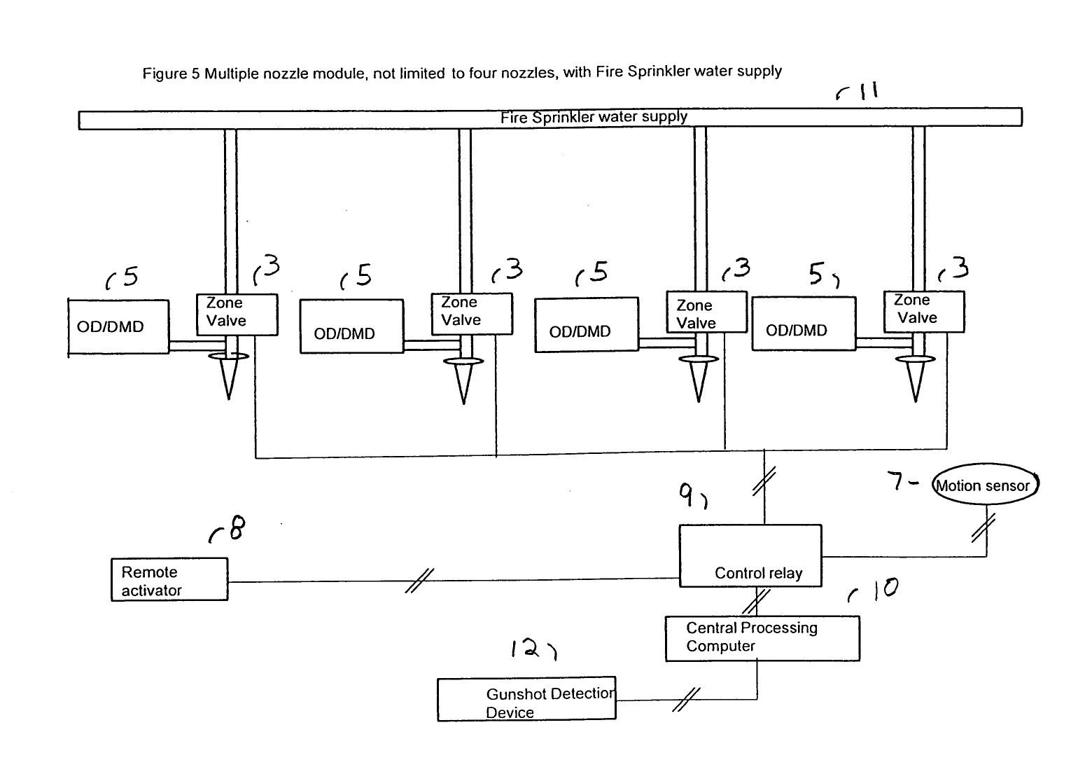

FIG. 5 shows an embodiment of a module using a fire sprinkler water supply with multiple zone valves and multiple nozzles.

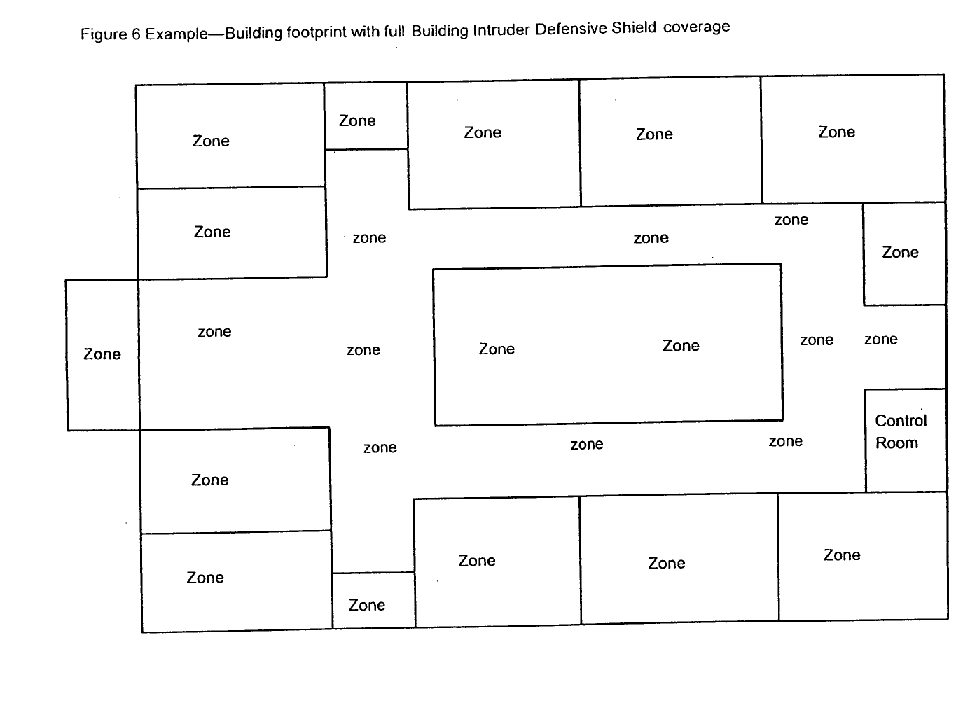

FIG. 6 shows a building footprint showing partial coverage of the building specific to entrances and hallways.

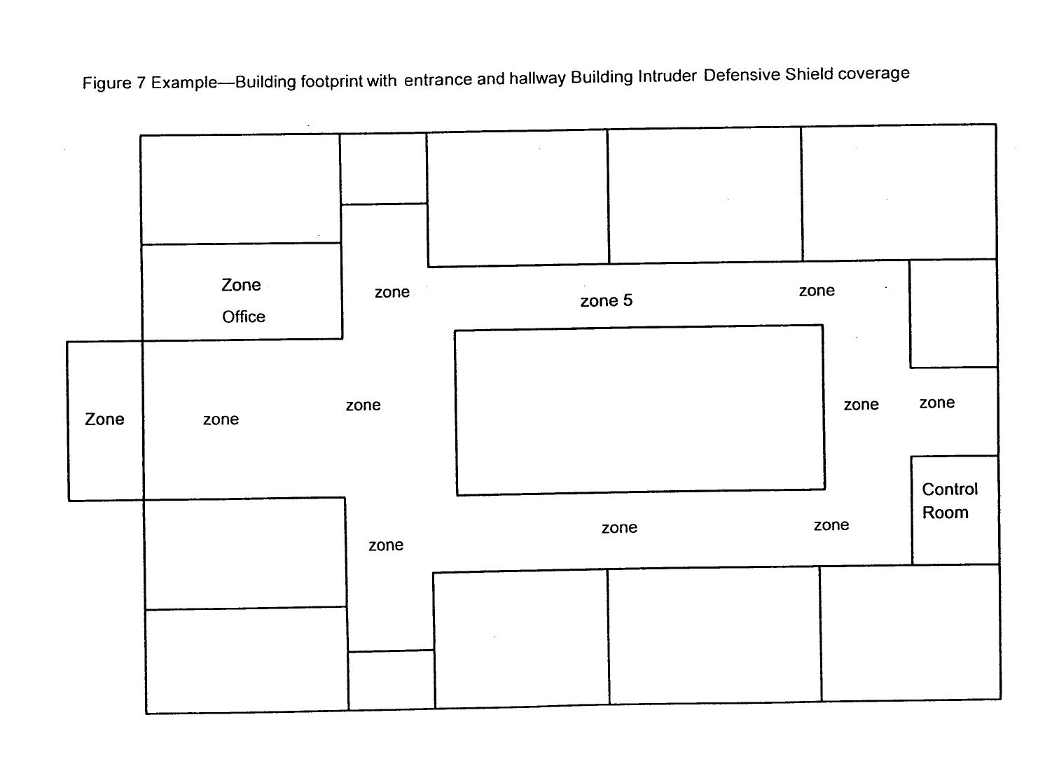

FIG. 7 shows a building footprint showing full coverage of all public use spaces in building.

Module Descriptions.

The system is module-based to accommodate any size of building. All plumbing is performed using materials consistent with local codes. Each module is connected via hard wired or wireless Local Area Network to the system control panel and consists of:

Cold water supply line

Cold water delivery lines

Expansion tank

Power supply

Single or multiple NC (Normally Closed) Zone valves

Single or multiple proximity sensor remote activation devices

Relay board with control relays

Single or multiple sensor devices

Single or multiple nozzles

Optional deterrent/dye metering device

### DETAILED DESCRIPTION OF DRAWINGS

Referring to FIGS. 1, 2 and 3, one embodiment of the module-based building intruder defensive shield 1 includes a cold water supply line 2 using the domestic water supply. The modules can be configured with one or more zone valves 3, one expansion tank 4, one or more optional deterrent/dye metering devices 5 and one or more nozzles 6 linked to one motion sensor device 7, a proximity sensor remote activation device 8, and one relay board with control relays 9 or with multiple expansion tanks 4, multiple zone valves 3, multiple optional deterrent/dye metering devices 5 and multiple nozzles 6 linked to one motion sensor device 7, a proximity sensor remote activation device 8 and one relay board with control relays 9. The control relays in each module is connected to the central processing computer 10 via hard wired or wireless Local Area Network. Each module is designed to provide coverage at one hundred or more square feet per nozzle. Nozzles have various configurations to accommodate multiple facility designs.

All plumbing is performed using materials consistent with local codes. The domestic water supply is plumbed into each expansion tank. The expansion tanks supply a pressurized volume of water to the zone valves. The zone valve is wired into the control relay. A power supply plugged into a building outlet provides the electrical current to the control relay to power the zone valve. The control relays are connected to the central processing computer via hard wired or wireless Local Area Network.

A proximity sensor remote activation device is located within eyesight of the location of the module. The proximity sensor remote activation device is connected to the central processing computer via a hardwired or wireless Local Area Network. A motion detection device is co 1mected to the control relays, which are, in turn, connected to the central processing computer. The central processing computer, upon receiving a signal from any sensor, using the logic built into the software, sends a signal to the control relay, causing the zone valve or valves in the module to open, which sends the cold water through the nozzles in the module. As the water passes through the piping to the nozzle, the optional deterrent/dye metering device, located on the flow side of the zone valve to ensure non-contamination of the water supply, meters out the calculated amount of agent into the water stream. The various designs of nozzles distribute the pressurized water in a pattern designed for maximum coverage.

All plumbing is performed using materials consistent with local codes. The building's cold water supply line is plumbed to each expansion tank first. A water line is then plumbed from the expansion tank to the zone valves. The optional deterrent/dye metering device may be connected on the flow side of the zone valve to ensure there is no contamination of the supply side water. Nozzles are attached to the flow side of the valves. The nozzles are securely affixed in strategic locations in/on the ceiling and walls to ensure optimum coverage and effectiveness for each module.

Referring now to FIGS. 4 and 5, another embodiment of the module-based invention connects the modules to the existing or new fire sprinkler system 11. The modules can be configured with one or more zone valves 3, one or more optional deterrent/dye agent metering devices 5 and one or more nozzles linked to one motion sensor device 7, a proximity sensor remote activation device 8, and one relay board with control relays 9. The control relays in each module is connected to the central processing computer 10 via hard wired or wireless Local Area Network. Each module is designed to provide coverage at one hundred or more square feet per nozzle. Nozzles have various configurations to accommodate multiple facility designs.

All plumbing is performed using materials consistent with local codes. The zone valve is plumbed into the fire sprinkler water supply system in a manner that does not impede the operation of the fire sprinkler system. The zone valve is wired into the control relay. A power supply plugged into a building outlet provides the electrical current to the control relay to power the zone valve. The control relays are connected to the central processing computer via hard wired or wireless Local Area Network.

The proximity sensor remote activation device is located within eyesight of the location of the module. The proximity sensor remote activation device is connected to the central processing computer via a hardwired or wireless Local Area Network. A motion detection device is connected to the control relays, which are, in turn, connected to the central processing computer. The central processing computer, upon receiving a signal from any sensor, using the logic built into the software, sends a signal to the control relay, causing the zone valve or valves in the module to open, which sends the cold water through the nozzles in the module. As the water passes through the piping to the nozzle, the optional deterrent/dye metering device, located on the flow side of the zone valve, meters out the calculated amount of irritant/dye into the water stream. The various designs of nozzles distribute the pressurized water in a pattern designed for maximum coverage.

When the zone valves deploy in a fire sprinkler system module, currently the fire sprinkler system water flow automatically sets off the fire alarm. In one configuration, the central processing computer will issue a lock-down alarm in conjunction with the alarm set off by the fire sprinkler system. Building occupants will be trained to adjust to the lock-down announcement. In a second configuration, an instant signal from the central processing computer will transfer the alarm from a fire alarm to a lock-down alarm. This configuration will be contingent upon local codes and local fire alarm capability to transfer the alarm from a fire alarm to a lock-down alarm.

As shown in FIGS. 1 through 5, the gunshot detection device 12 is connected to a central processing computer 10 via a hard wired or a wireless Local Area Network.

Configuration of the building intruder defensive shield within buildings is determined by the building owner. FIG. 6 shows an embodiment for full building coverage and FIG. 7 shows an embodiment for partial building coverage.

We claim:

1. A building intruder defensive shield comprising a shield module, the shield module comprising a cold water supply line, an expansion tank, a zone valve, a motion sensor device, an intruder alert means, a nozzle, and a relay board with a control relay, the control relay is connected to a central processing computer via a hard wired or a wireless Local Area Network,
the central processing computer comprising a software application means for recognizing sensor alerts, sending activation signals to the zone valve to turn on and off the water sprayed from the valve, and software applications to be used by mobile devices/wireless computers for delivery of system information to law enforcement and building occupants,
the cold water supply is plumbed to the expansion tank, zone valve and nozzle providing a flow of water to the expansion tank, the expansion tank comprising pressurized means to provide pressurized water to the zone valve,
the zone valve is connected to the plumbed cold water supply, expansion tank and nozzle between the expansion tank and nozzle to regulate the flow of water from the expansion tank to the nozzle,
the motion sensor device is located on a wall or ceiling of a building hallway or room to sense movement in that hallway or room or to receive a signal from the intruder alert means,
the motion sensor device is connected to the control relay via a hard wired or a wireless Local Area Network to send an electronic signal to the control relay of movement near the motion sensor device or of receipt of the signal from the intruder alert means,
the zone valve is further connected to the control relay via a hard wired or a wireless Local Area Network to receive electronic instructions to open or close, thereby allowing water to flow to the nozzle,
whereby when an intruder is discovered in the building, the intruder's location would be identified by the intruder alert means which would send a signal to the central processing computer activating the shield module, the central processing computer receiving the location of the intruder through the intruder alert means and the motion sensor device sends a signal to the zone valve in the area of the intruder's location to open, thereby allowing a timed burst of cold water throughout that area.

2. The building intruder defensive shield of claim 1 wherein the cold water supply comprises a domestic water supply.

3. The building intruder defensive shield of claim 1 wherein the cold water supply comprises a fire sprinkler system.

4. The building intruder defensive shield of claim 1 wherein the shield module further comprises at least one deterrent metering device.

5. The building intruder defensive shield of claim 4 wherein the deterrent metering device disperses a forensic dye.

6. The building intruder defensive shield of claim 4 wherein the deterrent metering device disperses a chemical deterrent.

7. The building intruder defensive shield of claim 1 wherein the intruder alert means is an occupant of the building.

8. The building intruder defensive shield of claim 7 further comprising a proximity sensor remote activation device connected to the control relay via hard wired or wireless Local Area Network to send an electronic signal to the control relay of the intruder's location, the proximity sensor remote activation device comprising a manual activation means.

9. The building intruder defensive shield of claim 8 wherein the proximity sensor remote activation device is conveniently located in the building hallway or room allowing an occupant to activate the shield module upon visually identifying an intruder.

10. The building intruder defensive shield of claim 1 wherein the intruder alert means is a gunshot detection means connected to the control relay via hard wired or wireless Local Area Network, the gunshot detection means is strategically located in the building to detect and identify a gunshot signature and send a signal to the control relay providing the location where the gunshot occurred.

11. A building intruder defensive shield comprising a shield module, the shield module comprising a cold water supply line, a plurality of expansion tanks, a plurality of zone valves, a plurality of motion sensor devices, a plurality of intruder alert means, a plurality of nozzles, and a relay board with a control relay, the control relay is connected to a central processing computer via a hard wired or a wireless Local Area Network,
the central processing computer comprising a software application means for recognizing sensor alerts, sending activation signals to one or more of the zone valves to turn on and off the water sprayed from the valve, and software applications to be used by mobile devices/wireless computers for delivery of system information to law enforcement and building occupants,
the cold water supply is plumbed to one or more of the expansion tanks, zone valves and nozzles providing a flow of water to each expansion tank, each expansion tank comprising pressurized means to provide pressurized water to each zone valve,
each zone valve is connected to the plumbed cold water supply, expansion tank and nozzle between the expansion tank and nozzle to regulate the flow of water from the expansion tank to the nozzle,
each motion sensor device is located on a wall or ceiling throughout a building hallways or rooms to sense movement in that respective hallway or room or to receive a signal from the intruder alert means,
each motion sensor device is connected to the control relay via a hard wired or a wireless Local Area Network to send an electronic signal to the control relay of movement near the motion sensor device or of receipt of the signal from the intruder alert means,
each zone valve is further connected to the control relay via a hard wired or a wireless Local Area Network to receive electronic instructions to open or close, thereby allowing water to flow to the respective nozzle,
whereby when an intruder is discovered in the building, the intruder's location would be identified by the intruder alert means which would send a signal to the central processing computer activating the shield module, the central processing computer receiving the location of the intruder through the intruder alert means and the motion sensor device sends a signal to the zone valve in the area of the intruder's location to open, thereby allowing a timed burst of cold water throughout that area.

12. The building intruder defensive shield of claim 11 wherein the cold water supply comprises a domestic water supply.

13. The building intruder defensive shield of claim 11 wherein the cold water supply comprises a fire sprinkler system.

14. The building intruder defensive shield of claim 11 wherein the shield module further comprises at least one deterrent metering device.

15. The building intruder defensive shield of claim 14 wherein the deterrent metering device disperses a forensic dye.

16. The building intruder defensive shield of claim 14 wherein the deterrent metering device disperses a chemical deterrent.

17. The building intruder defensive shield of claim 11 wherein the intruder alert means is an occupant of the building.

18. The building intruder defensive shield of claim 17 further comprising a plurality of proximity sensor remote activation devices connected to the control relay via hard wired or wireless Local Area Network to send an electronic signal to the control relay of the intruder's location, each proximity sensor remote activation device comprising a manual activation means.

19. The building intruder defensive shield of claim 18 wherein each proximity sensor remote activation device is conveniently located throughout the building hallways or rooms allowing an occupant to activate the shield module upon visually identifying an intruder.

20. The building intruder defensive shield of claim 11 wherein the intruder alert means comprises a plurality of gunshot detection means connected to the control relay via hard wired or wireless Local Area Network, each gunshot detection means is strategically located throughout the building to detect and identify a gunshot signature and send a signal to the control relay providing the location where the gunshot occurred.
